(19) United States
(12) Patent Application Publication
(10) Pub. No.: US 2008/0044802 A1
(43) Pub. Date: Feb. 21, 2008

(54) MULTIMEDIA STANDARDIZED CURRICULUM EDUCATION SYSTEM AND METHOD OF OPERATION

(75) Inventors: Kenneth M. Leonard, Austin, TX (US); Alan D. Davis, Austin, TX (US)

Correspondence Address: HULSEY IP INTELLECTUAL PROPERTY LAWYERS, P.C., 919 Congress Avenue, Suite 919, AUSTIN, TX, 78701, US

(73) Assignee: Ignite Learning, Inc.

(21) Appl. No.: 11/849,045

(22) Filed: Aug. 31, 2007

Related U.S. Application Data
(63) Continuation of application No. 11/333,767, filed on Jan. 17, 2006.

(51) Int. Cl. G09B 7/00

(52) U.S. Cl. 434/322

(57) ABSTRACT

A self-contained multimedia presentation system presents a menu-driven classroom curriculum in compliance with standardized educational requirements. The disclosed system includes a multimedia presentation device for projecting video, images and playing audio recordings. The multimedia presentation device includes an embedded computing device having a minimal set of control functions for presenting to a user a simplified control interface facilitating use of said multimedia presentation device. A pre-programmed storage medium includes engaging multimedia educational programs for uniquely presenting educational material complying with predetermined educational objectives. The predetermined educational objectives prepare learners for specific standardized achievement goals. Included testing features assist in evaluating student achievement and fulfillment of standardized educational requirements. The system is flexible in use and can be used according to a prescribed usage plan (included), or ad-hoc as needed to assist in teaching.

This application claims the benefit of priority to U.S. Non-Provisional patent application Ser. No. 11/333,767 entitled “MULTIMEDIA STANDARDIZED CURRICULUM EDUCATIONAL SYSTEM & METHOD OF OPERATION,” by Kenneth Leonard filed on Jan. 17, 2006, and is incorporated herein by reference in its entirety for all purposes.

### FIELD

The present invention relates generally to educational devices and systems. More specifically, the present invention relates to automated systems for delivering instructional materials to students in a classroom or similar environment. Even more particularly, the disclosed subject matter provides a multimedia standardized curriculum educational system for teaching a broad array of classroom subjects for achieving predetermined educational objectives and discloses various methods for operating the disclosed system.

### DESCRIPTION OF THE RELATED ART

In today's educational system a number of programs require schools to show annual progress in reading, math, social studies, sciences, and other disciplines. These programs base progress of a school's or educational district's education program on testing of the students. With such programs, oftentimes there is the need for students to achieve predefined social and/or emotional intelligence levels. Schools seeking to achieve such educational objectives in a formalized, overt way are truly focusing on producing student results that will prepare the students for real-world situations.

Today's teaching methodologies must include innovative techniques that help lift the stragglers in a classroom. These methodologies need to take into account a wide range of learning styles and other variables in providing different types of instruction that work best for different types of students.

Conventionally, however, text books and related presentation materials have been the only means for reaching a wide variety of students. While textbooks have many advantages over less organized collections of instructional materials, they also have many drawbacks. Textbooks are typically designed with organized content, reinforcement examinations and answer keys, bibliographies and follow up materials. These features are intended to work together to assure that educational programs meet standards established by the educational departments and similar organizations. While textbook content in this format may be comprehensive, the delivery of content in this format is not affective for many students. The delivery of this content is linguistically focused and only a portion of learners have a linguistic learning style. It is also a well known fact that many students find textbooks to be boring in nature. In order for any educational program to be successful, it is important to take learning styles into account and find ways to deliver content in a way that is affective for a broad range of students.

Presently, another tension exists of known curriculum structures being designed so that common instructional materials serve only a hypothetically average, linguistic student. Many teachers typically modify instructional materials to compensate for differences between the teacher's actual students and the hypothetical student. However, such attempts widely vary from teacher to teacher, sometimes with very different and unpredictable results.

A further drawback of conventional instructional materials arises from the varied instructional techniques associated with the use of such materials. For example, in some instances, a particular teachers' experience with the subject matter being taught may handicap the educational process. Generally speaking, education suffers when a teacher with less experience in a particular subject is required to present the instructional materials when compared to a teacher who has more experience. For example, if a teacher having little formal training in science is required by a school to teach a standardized science curriculum, highly unpredictable and potentially undesirable learning results may arise in his/her students. In addition, a negative learning experience can lead to a negative attitude toward a specific topic.

Conventional instructional materials, such as textbooks, that may include a great deal of textual material are also severely limiting for students who are not linguistic learners. These alternative learning styles include kinesthetic, logical-mathematical, visual-spatial, musical and others. For example, with many visual learners, the greater the degree of visualization possible in exploring or learning a topic, the more learning occurs. Specifically, the more pictures and graphical representations supplied, and the more detail provided in such pictures and graphical representations, the more effective the learning will be. However, the limited number of static pictures or graphical representations contained in typical textbooks, even when augmented by conventional supplemental materials, falls far short of the degree of visualization needed to effectively present instructional materials for many students.

One attempt to solving these and similar problems seeks to provide video-based software tutorial or training systems. Such systems seek to provide a level of flexibility in pulling together information from a variety of sources and providing a system for managing this variety of instructional materials. Such systems seek to make effective use of educational video tapes, laser video disks, VHF and UHF TV, “live” video via camcorders, closed circuit TV, satellite TV, and CATV to augment instructional materials provided by a teacher. These video resources provide improved visualization of the concepts being taught. As a result, the educational process improves to a limited degree. Typically, such resources are prepared by those who fully understand the subject matter presented. These individuals commonly have a good feel for presenting the instructional materials in an understandable way. Thus, the educational process is enhanced.

A significant problem exists with such systems, however, owing principally to there being so many options from which to choose. In addition, for many multimedia environments, complex software and hardware configurations must be mastered by the teachers, many of whom do not possess computer or multimedia system usage skills. As a result, although there may be many options of advanced multimedia instructional materials for teachers to use in supplementing the available text books for different subjects, the reality often arises that teachers seldom use such tools. The reality is that many teachers focus on textbook usage, and students may lose interest in a subject or school in general.

A need exists, therefore, for a more effective method and system for achieving key educational objectives set forth by schools or educational institutions.

A need exists for a system and method for augmenting the conventional textbook learning system. This system must be easy to use by a teacher who may not possess even basic computer usage skills.

Still another need exists for a method and system that, by provided supplemental educational content using a variety of learning modalities, aids in teaching the greatest number of students according to different individuals' learning styles.

### SUMMARY

In satisfying the above-stated needs, the present disclosure provides an automated system for delivering instructional materials to students in a classroom or similar environment. The disclosed subject matter provides a multimedia, standardized-curriculum educational system for teaching a broad array of classroom subjects in achieving predetermined educational objectives and discloses various methods for operating the disclosed system. As such, the present disclosure supports the educational objectives of complying with major educational goals for a school or education system by augmenting the conventional textbook learning system. The disclosed system and method may be easily used by a teacher who may not possess computer skills and facilitates the delivery of supplemental educational content using a variety of learning modalities, thereby teaching the greatest number of students according to different individuals' learning needs.

According to one aspect of the disclosed subject matter, therefore, here is provided a self-contained multimedia presentation system for presenting a menu-driven classroom curriculum in compliance with standardized educational requirements. The disclosed system includes a multimedia presentation device and audio speakers for projecting video, images and playing audio recordings. The multimedia presentation device includes an embedded computing device having a minimal set of control functions for presenting to a user a simplified control interface facilitating use of said multimedia presentation device. A pre-programmed storage medium includes multimedia educational programs for presenting educational material complying with predetermined educational objectives. The predetermined educational objectives prepare learners for specific standardized achievement testing. The standardized achievement testing for which the learner is prepared assures achievement by the learners in satisfying said standardized educational requirements.

These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGUREs and detailed description. It is intended that all such additional systems, methods, features and advantages that are included within this description, be within the scope of the accompanying claims.

### BRIEF DESCRIPTIONS OF THE DRAWINGS

The features, nature, and advantages of the disclosed subject matter will become more apparent from the detailed description set forth below when taken in conjunction with the drawings in which like reference characters identify correspondingly throughout and wherein:

FIGS. 1 and 2 show, respectively, a back aspect and a front aspect of the multimedia curriculum unit of the disclosed subject matter;

FIG. 3 illustrates the projector's control panel of the disclosed multimedia curriculum unit;

FIGS. 4 and 5 display, respectively, component parts and a fully assembled support assembly for the disclosed subject matter;

FIGS. 6 and 7 show interior aspects of the disclosed multimedia curriculum unit;

FIG. 8 illustrates an initial screen for using the preset multimedia curriculum in a social sciences application of the disclosed subject matter;

FIGS. 9 through 18 show varying aspects of the multimedia curriculum device of the disclosed subject matter in the aforesaid social sciences application; and

FIGS. 19 through 22 present features of a science curriculum application of the multimedia curriculum unit of the disclosed subject matter.

### DETAILED DESCRIPTION OF THE SPECIFIC EMBODIMENTS

This disclosure presents a multimedia standardized curriculum educational system and method of operation presenting to the user and learner essentially a curriculum on wheels that permits delivering lessons professionally and comprehensively to support the educational objectives of many different types of learning environments. The present embodiment in a computer, a projector, and speakers, a pre-loaded multimedia content that conforms to predetermined learning objectives such as, but not limited to, those of public schools in the areas of natural and social sciences. With the presently disclosed system a user may simply provide power to the unit and begin teaching one or more students, as easy as a book may simply be opened and used for teaching. However, the material presented and its use is rich in content and multimedia applications; far richer and far more versatile than conventional textbooks and printer materials.

The multimedia curriculum unit provides an aid to teachers in assuring that students become more interested in the content and participate more in class discussions and activities. Using the multimedia curriculum unit, students may achieve a deeper understanding of the material, and may analyze that information and apply it in new ways. Teachers find that they are able to integrate technology into the curriculum in a meaningful and seamless way, and that the multimedia curriculum unit's wide variety of multimedia content appeals to students' different learning styles and interests.

The multimedia curriculum unit is a flexible teaching tool that can be used and adapted in a number of ways. A teacher may, for example, use the multimedia curriculum unit 30 minutes per week (e.g., 10-15 minutes 2-3 times per week) to present multimedia courses are organized into units and topics. As another example, the teacher may use it for most of every period, every day.

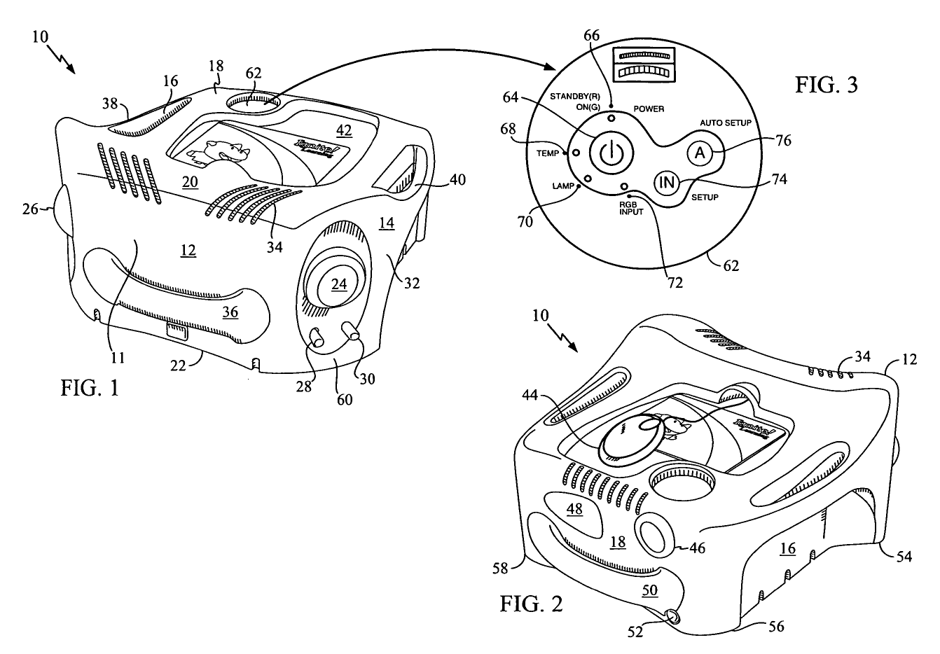

To explain important features of the present disclosure, FIGS. 1 and 2 shows aspects of the multimedia curriculum unit 10 of the disclosed subject matter. FIG. 1 provides a back view, while FIG. 2 provides a front view of multimedia curriculum unit 10, which includes a molded material outer casing 11 formed in a roughly rectangular configuration. Casing 11 includes back panel 12, side panels 14 and 16, front panel 18, top panel 20, and bottom panel 22. Back panel 12 includes speaker grids 24 and 26 and associated audio control 28 for volume and audio control 30 for tone/base control. Side panel 14, in the illustrated embodiment, also includes a USB port 32 for a variety of connections with the processing circuitry of multimedia curriculum unit 10. Numerous ventilation ports 34 appear around multimedia curriculum unit 10, including back panel 12, and side handles 38 and 40 assist with unit portability. Mouse pad 42 provides a surface for operation of a pointing device, such as mouse 44 of FIG. 2, although other pointing devices may achieve the same functionality.

FIG. 2 shows that multimedia curriculum device 10 includes on front panel 18 the ability to project images via projection lens 46. On front panel 18 may also appear ventilation port 34 and label pad 48. Handle 50 further assists in the portability of multimedia curriculum unit 10. Power button 52 controls overall power to multimedia curriculum unit 10. Casing 11 provides a novel aspect of multimedia curriculum unit 10 by its providing not only a rugged, easily handled single construction device, but also providing at bottom panel 22 corner base segments 54, 56, 58, and 60, which permit placing the unit on a flat surface or table firmly and securely during its operation.

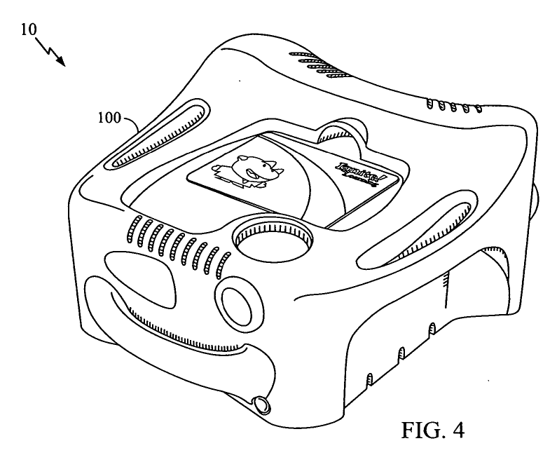

Multimedia curriculum unit 10, as FIG. 3 shows, requires only a minimal amount of control input. FIG. 3 displays projector control panel 62 for providing projector control and power to the projector functions of multimedia curriculum unit 10. As shown in FIG. 1, projector control panel 62 appears on top panel 20 and, as FIG. 2 shows, includes power button 64. Power button 64 activates POWER LED 66 to show green, red, or orange to indicate the operating condition of multimedia curriculum unit 10. In addition, power control panel 62 may TEMP (temperature status) LED (light emitting diode) 68, LAMP (projection lamp) LED 70, and RGB INPUT (red-green-blue signal) LED 72. INPUT button 74 provides status and control relating to input data for the projector circuitry within multimedia curriculum unit 10. AUTO SETUP button 76 initiates controls and functions within multimedia curriculum unit 10 for automatic keystoning and setup of internal processing and projecting functions to permit automatic use.

POWER LED 66 illuminates red when the projector is in standby mode, and it illuminates green when a picture starts to be projected. Moreover, POWER LED 66 assumes a red, green, orange color and may appear as either illuminated or flashing to convey different messages to the user. For example an illuminated red may mean that the projector is in a standby mode and image projection is possible by pressing the POWER button. When green and flashing, the message may be that the projector is preparing for projection after the power is turned on and that after a short period a picture will be projected, while an illuminate green may mean that a picture is being projected. When orange and illuminated, the message may be that the lamp is cooling down after the power is turned off, and when flashing that the projector is preparing for projection after the power is turned on.

TEMP LED 68 illuminates if an abnormally high temperature is detected inside the projector or around it. If the temperature rises above a certain level, the power supply will be turned off automatically and the indicator will flash. LAMP LED 70 illuminates when it is time to replace the lamp unit. It flashes if a circuit abnormality is detected. RGB INPUT LED 72 illuminates when a signal is being input to the RGB IN connector (the default input used by the device). The indicator will light when computer and projector of multimedia curriculum unit 10 are powered on. INPUT button 74 switches the input signals from the connected equipment. AUTO SETUP button 76 allows for automatic adjustment of the projection settings in accordance with the signal being input. In addition, the angle of tilt of the projector will be automatically detected and adjusted in order to correct any keystone distortion.

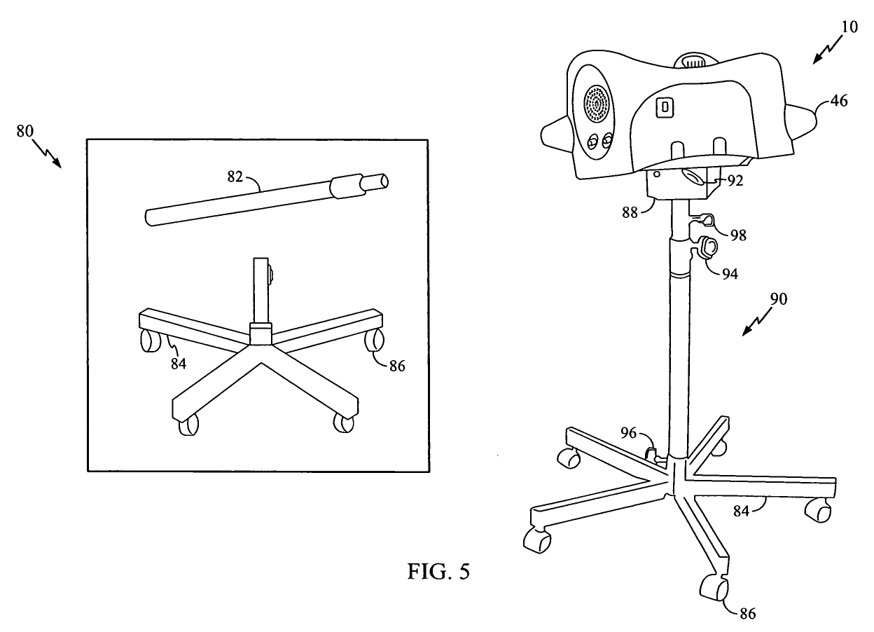

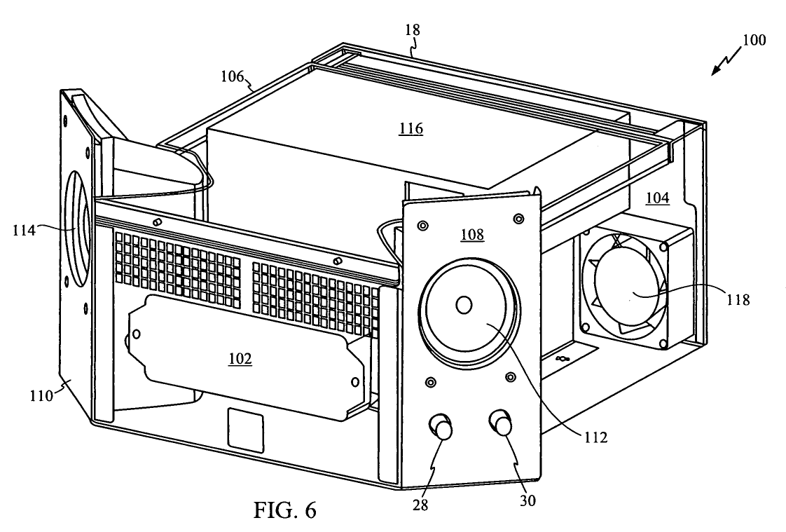

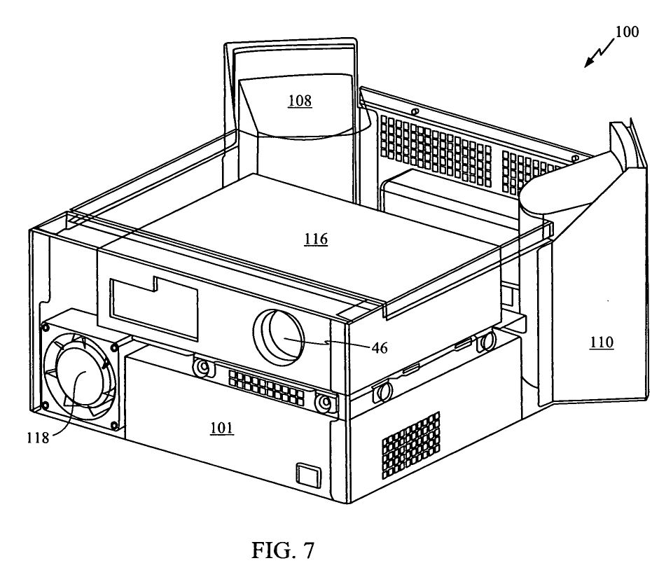

An attractive feature of multimedia curriculum unit 10 is the ability to not only rest on a flat surface, but also to operate on a wheel base that permits its positioning essentially at any location within a classroom or similar setting. FIG. 4, therefore, displays component parts for a support assembly 80 capable of independently raising multimedia curriculum unit 10 to a level above a floor. Support assembly 80, very simply, include vertical shaft 82, which may provide a variety of vertical adjustment features and may interface with a shaft receptacle (not shown) on bottom panel 22. The other end of vertical shaft 82 fits with wheel base 84, which includes a number of caster wheels 86. Caster wheels 86 allow for easy movement of the fully assembled unit 90 of FIG. 5. One or more of these casters also allow for locking so that the unit does not roll inadvertently.

FIG. 5 also shows tilt mechanism 88 for permitting a desirable amount of tilt control in the use of fully assembled unit 90. Thus, fully assembled unit 90 permits a user to stand at back panel 12 from where audio output from speaker grids 24 and 26 present sounds to classroom students. Visual output from projection lens 46 emanates forward from front panel 18 and onto a screen (not shown). Serial port 32 permits the loading and removal of standardize curriculum materials for classroom use, as well as input for mouse or other peripheral controls.

Support assembly 80, as FIG. 5 shows, also includes tilt adjustment screw 92 for permitting adjustment of tilt mechanism 88 and height adjustment screw 94 for adjusting the length of vertical shaft 82, thereby providing to a use a broad array of positions and aspects from which to control multimedia curriculum unit 10. Furthermore, support assembly includes securing screw 96 for securing vertical shaft to tilt mechanism 88 and securing screw 98 for securing wheel base to vertical shaft 82.

In the use of support assembly 80, for example, two individuals, may place wheel base 84 on level ground with wheels on the bottom and lock two locking wheels (not shown) on wheel base 84. Vertical shaft 82 may be inserted into wheel base 84. Base Attachment Knob 96 may be tightened firmly until vertical shaft 82 is securely attached to wheel base 84. Multimedia curriculum unit 10 and the attached tilt mechanism 92 may then be carefully lifted and placed onto vertical shaft 94. Attachment Knob 98 may then be tightened firmly until tilt mechanism is secure in vertical shaft 82. The result will be a secure and highly portable fully assembled unit 90 including multimedia curriculum unit 10.

FIGS. 6 and 7 show an interior aspects of the projector unit 100, which fits within casing 11 of multimedia curriculum unit 10. Computer and projector unit 100 includes back inner panel 102, side inner panels 104 and 106, and front inner panel 107. Speaker panels 108 and 110 include speakers 112 and 114, respectively. Audio controls 28 and 30, in the disclosed embodiment protrude from speaker panel 108, however, they could be placed in a number of locations. Within computer and projector unit 100 appears projector unit 116, which may be formed from an advanced multi-functional video projector device made by one of a variety of manufacturers. From projector unit 116, projected images project from lens 46 in response to the various controls and programs herein described. For temperature control, computer and projector unit 100 may further include cooling fan 118.

Computer and projector unit 100, therefore, includes a computer 101 and a projector unit 116. Computer 101 may be one of any number of versatile personal computers having the desirable form factor and functionality to present the multimedia curriculum content herein described. One embodiment of the disclosed subject matter includes as projector control unit 116 a Panasonic PT-LM1U SVGA LCD Projector. Using such a device for projector unit 116 provides an approximately 3.5 pound unit generating approximately 1,200 lumen projectors with having a desirable combination of weight, brightness and cost.

For example, one embodiment of the projector unit 116 may provide approximately 1,200 ANSI lumens of brightness in an optical system including a high-efficiency 130 UHM lamp with high contrast (400:1 ratio) images in a 800×600 native SVGA native resolution (while providing resizing technology to support UXGA). Utilizing artificial intelligence (in high lamp power mode), the projector may adjust lamp brightness to optimize on-screen imaging. For darker scenes, the projector unit may automatically lower the brightness to produce deeper blacks and make light areas “pop out,” improving overall image quality. The particular brand and technical specifications of the projector are flexible.

One embodiment of projector unit 116 includes plug-and-play functions including one-touch auto set-up with vertical and horizontal digital keystone correction and a speed start function whereby an image appears only five seconds after pressing the power button. When the presentation is completed, a direct power off function disconnects the power cable, allowing the presenter to immediately move the projector while the cooling fan keeps operating until the lamp is cooled. The projector is preset to automatically enter standby mode after 15 minutes of idle time.

Projector unit 116 may also include a plurality of anti-theft functions including a security lock, user password protection, control panel lock-out (which can only be canceled by the unit's remote control), and text superimposing whereby a user can program a text line—such as a school's name, URL or warning of choice—at the bottom of the projected image.

The preferred embodiment of projector unit 116 may automatically resize 1080i and 720p images for 16:9 wide-aspect display; 480p, 480i and 576i component video signals and S-Video can also be displayed in either 4:3 or 16:9. The unit provides wide compatibility ranging from NTSC, NTSC 4.43, PAL, PAL-M, PAL-N, PAL-60 and SECAM. The projector unit is also sRGB compatible to ensure uniform, accurate color reproduction with other sRGB-compatible imaging devices.

In operation, projector unit 116 provides an index window, which allows any image in a presentation (RGB or video input) to be frozen, stored in memory and displayed on the left side of the screen, while display of subsequent images continues on the right. The unit has selectable color temperature (standard/high/low) and picture mode (standard/dynamic/natural) that matches picture quality to the source and room conditions.

Speakers 112 and 114 of the disclosed embodiment may be, for example, computer 101 audio speakers, such the Sound Blaster® SBS270® 2-piece speaker system designed for computer 101 audio performance. As such, speakers 112 and 114 may connect to computer 101, as well as CD/MP3 players 18- and other audio devices, while fitting comfortably within casing 11. Such speakers 112 and 114 may provide high-performance drivers, a built-in bass port, and 10 Watts RMS power. As such speakers 112 and 114 deliver power and performance making computer 101 audio performance more engaging and dynamic. Speakers 112 and 114 may also provide sockets for headphones and a microphone. A tone control adds further refinement to these stylish speakers, which make everyday computer 101 audio entertainment more enjoyable. In one embodiment a frequency response may range from 110-20000 Hz in a speaker set having dimensions of 3.94 in.×3.78 in.×7.87 in.

Computer 101 may, for example, be a U-Buddie UB-4m23, sold by ECS Computer Systems of Taiwan, which in a compact design delivers power and connectivity to support the functions of the present disclosure. Specific details regarding the U-Buddie UB-4m23 may be obtained at the www.ECS.com.tw Internet website. Note, however, that the U-Buddie 4m23 computer provides but one example of a desk-top computer capable of satisfying the functional requirements of the disclosed subject matter.

Projector unit 116 may provide, for example, two lamp power settings (high and low); whisper-quiet operation (only 30 dB in low lamp mode); advanced shutter function for image and sound muting; projection on screens ranging in size from 33″ to 300″; a power 3× digital zoom; built-in 2-watt speaker; eight-language on-screen menu with graphical icons; discrete S-video and video inputs for connecting two DVD/video sources at the same time; fan control for high elevations (above 4,600 feet); still mode; freeze function; and a card-type remote control. The dimensions of its space-saving compact body are 10 3/32″ W×2 11/32″ H×8 7/32″ D.

Multimedia curriculum unit 10 may provide to a user a complete science pedagogy with a full suite of science courseware for middle school education in conformance with a known set of educational standards, such as the Texas Assessment of Knowledge and Skills (TAKS) and Texas Assessment of Academic Skills (TAAS) tests. Multimedia curriculum unit 10, therefore, offers a multimedia-rich, online learning environment that provides full coverage of science curriculum as established by the TAKS and TAAS tests. The courses are carefully designed to support the best practices of middle school science instruction, taking into account the developmental characteristics of early adolescence, the great variety of students' learning styles and interests, and teachers' needs for an effective and engaging instructional tool.

Multimedia curriculum unit 10's science courses may include earth science, life science, and physical science. Because different state or regional educational requirements often differ in the content required by their standards, multimedia curriculum unit 10's course materials are easily tailored to meet specific state curriculum needs, including integrated and spiral approaches.

The instructional approach for multimedia curriculum unit 10 provides for teaching students in the ways they learn best. The science curriculum may include topics such as the effects of science on society for linking classroom content to the larger world; learning by doing for using inquiry-based experiments to develop scientific skills; expectation failures for creating powerful teaching moments from students' own explanations, and flexible implementations for supporting the practical demands of the classroom. The science curriculum, therefore, provides a comprehensive, research-based instruction set that provides the appropriate quantity and quality of instructional materials to effectively teach students. This makes the multimedia curriculum unit 10 a valuable addition to the catalog of instructional tools available to teachers and students.

The standardized science curriculum that multimedia curriculum unit 10 may support takes a multimedia approach superior to traditional print-based instructional materials. The multimedia curriculum unit 10 narrated animations graphically demonstrate a variety of systems and phenomena, such as why seasons occur and what causes the phases of the moon. Interactive environments that allow students to explore hidden worlds—from the cellular level to the Earth's interior dynamics—give concrete meaning to ideas that would otherwise remain vague and abstract. Multimedia curriculum unit 10 may also include videos of natural events and new technologies that students never see in their daily lives help to bring the world into the classroom. The combination of visual, aural, and interactive materials helps students learn concepts faster and more completely than traditional print-based instructional materials. Multimedia curriculum unit 10's multimedia courseware also allows teachers to account for diverse learning styles. Concepts are conveyed through song, poetry, video, animation, interactive diagrams, and many other formats. Then, because each concept is presented through multiple media pieces, each emphasizing a different combination of learning styles, multimedia curriculum unit 10's courseware allows students to find the media piece (or pieces) that speak to how they learn best. Multimedia caters to diverse learning styles much more effectively than traditional print-based instructional materials.

With its full suite of science courseware for middle school, multimedia curriculum unit 10 offers a multimedia-rich, online learning environment that provides full coverage of science curriculum. The courses are carefully designed to support the best practices of middle school science instruction, taking into account the developmental characteristics of early adolescence, the great variety of students' learning styles and interests, and teachers' needs for an effective and engaging instructional tool.

The multimedia curriculum unit 10 science courses include earth science, life science, and physical science. Because states often differ in the content required by their standards, multimedia curriculum unit 10 course materials are easily tailored to meet specific state curriculum needs, including integrated and spiral approaches.

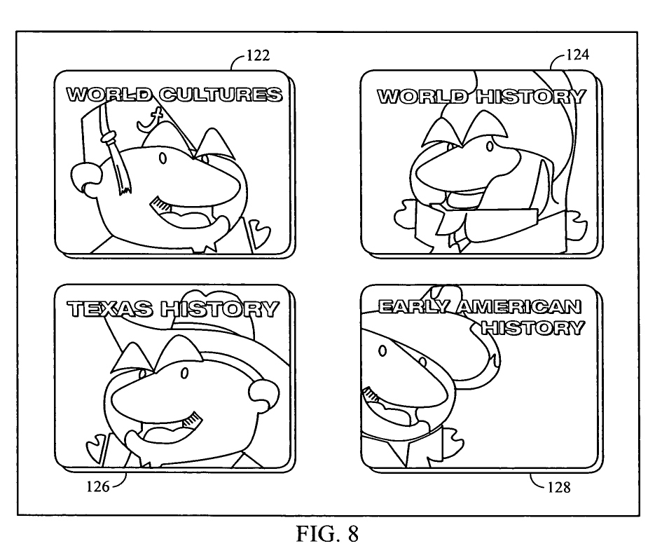

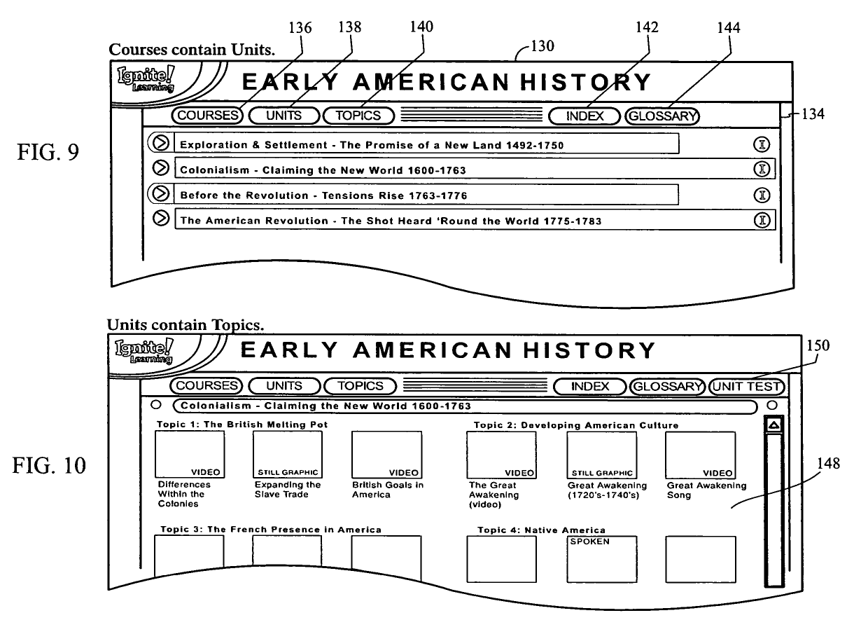

To more completely appreciate the functional features of the disclosed subject matter, FIG. 8 illustrates an initial screen for using the preset multimedia curriculum in an American history application of the disclosed subject matter. For example, the history application of the present embodiment, include a Social Sciences Curriculum menu panel 120 that allows the user to navigate to a World Cultures curriculum 122, a World History curriculum 124, a Texas History curriculum 126, and an Early American History curriculum 128. Each of these curricula includes at least one course as FIGS. 9, 10 and 11 depict. That is, upon selecting Early American History curriculum 128, multimedia curriculum unit 10 displays on curriculum or course screen 130, for example, units listings 132 of study with in the Early American History curriculum 128.

Course screen 130 also displays curriculum navigation button panel 134, which includes selectable buttons, such as COURSE button 136, UNITS button 138, TOPICS button 140, INDEX button 142, and GLOSSARY button 144. Each such button activates a respective screen of functions making available different and respective aspects of a particular standardized multimedia curriculum.

Specific examples of curriculum content may include a Early American History course a unit entitled “Exploration & Settlement—The Promise of a New Land 1492-1750,” topics may include Columbus, Cortés and the Aztecs, Age of Exploration, The Quest for Freedom, Freedom of Religion, and Planting the Seeds of Liberty. In a unit entitled “Jamestown: The First Permanent British Colony” may be taught the topics of Working for a Living, Trading Overseas, Regional Differences, Building Early Society, and Scientific Innovations of the New World. In a unit entitled “Colonialism—Claiming the New World 1600-1763” may be taught the topics of The British Melting Pot, Developing American Culture, The French Presence in America, Native America, A Clash of Cultures, Expanding People—Expanding Territory, King Philip's War (1675-1676), French & Indian War (1754-1763), Colonial Unity in War, Aftermath of War, Continuing Tensions, and England Takes Control.

A unit entitled “Before the Revolution—Tensions Rise 1763-1776” may be presented the topics of Proclamation of 1763, America's Coming of Age, America's Divided Loyalty, England's New Debt, British View of America, British Global Power, Events Leading to the Boston Massacre (Mar. 5, 1770), Events Leading to the Boston Tea Party (Dec. 16, 1773), Events Leading to the Second Continental Congress (May 1775), The Spirit of Revolution-Declaration of Independence (Jul. 4, 1776), and A Brief History of Democracy

A unit entitled “The American Revolution—The Shot Heard 'Round the World 1775-1783” may include topics such as The Beginning of War, Key Battles, Americans Who Rose to Power, British Forces, The Continental Army, Foreign Allies, The Promise of Freedom, The Makings of a New Government, The Price of Victory, Britain After the War, The Impact on France, and The Continual Influence of the Revolution.

A unit entitled “The Birth of the Constitution—Forging a Democracy 1781-1796” may include topics of The Articles of Confederation, An Uprising Among the Poor, Slavery in the Land of the Free, Our Nation's Founders, Federalists vs. Antifederalists, The Constitutional Convention, The Bill of Rights, American Influences, European Influences, Who was George Washington?, Setting a Precedent, and The Key Actions that Made for a Good Presidency.

A unit on “Understanding Our Democracy—The Rights and Responsibilities of the Citizen” may include topics of 1787-Present, Three Branches, States' Rights, The Influences of Factions, The Electoral Process, Constitutional Amendments, How a Bill Becomes a Law, The Individual vs. the State, Limited Freedom of Speech, Sacrificing for the Greater Good, Voting, The Media, Protest and Civil Disobedience, and Early American History.

A unit entitled “America's New Politics and Diplomacy—America Comes of Age 1789-1815” may include topics of The Presidents, their Cabinets, and their Relationships with Congress, The Vice Presidency, Federalism vs. Republicanism, The First Supreme Court, Judiciary Act of 1801, Marbury vs. Madison, France, Jay's Treaty (1794)&Pinckney's Treaty (1795), The Barbary States (1801-1805), Tecumseh and the Battle of Tippecanoe (1811), Prewar Tensions with England, and The War of 1812.

In a unit entitled “The Growth of American Society—Defining America 1795-1815” may be taught the topics of Alexander Hamilton and the National Bank, Barriers to Foreign Trade, Early Industry, The Changing Character of the Nation, Coming to Terms with Liberty, Literature and Religion, Fighting for One's Beliefs, The Alien and Sedition Acts (1798), The Era of Good Feelings, Population Growth, Land Expansion, and Explorers.

A unit entitled “The Age of Jackson—The Impacts of Jacksonian Democracy 1800-1850” may include topics of Andrew Jackson, The Culture He Influenced, The Politics that Surrounded Him, The Cherokee and the Trail of Tears, Official Policy and Rhetoric, Contested Land on the Frontier, The Monroe Doctrine, Florida, Texas, and California, The Mexican War (1846-1848), Wars and Bloodshed in Native America, Living on the Broadening Frontier and The Culture of the Frontier.

Clearly, from the above listing, a user has with multimedia curriculum unit 10 an extremely robust set of instructional materials providing effective means of conveying standardized curriculum material in, as in the example listing, the social science area of Early American History. With such a robust set of materials, the disclosed subject provides desirable means for accessing and using the multimedia content.

Accordingly, once a user selects a unit within a course, as shown in FIG. 9, for example, unit listing 132, entitled “Colonialism—Claiming the New World 1600-1763,” multimedia curriculum unit shows topics screen 146, see FIG. 10, from which a selection of a topic 148 may occur. For example, upon selecting “Expanding People, Expanding Territory-Settling the Americas,” the user may navigate to the related instructional material. FIG. 10 also shows on curriculum navigation button panel 134 an additional UNIT TEST button 150, which a user may select for displaying an interactive unit test.

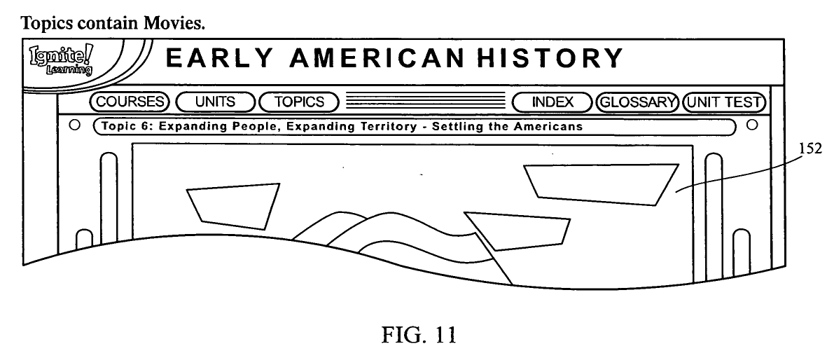

Upon selecting such a topic 148, multimedia curriculum unit 10 shows movie screen 152 of FIG. 11. At movie screen 152, multimedia curriculum unit 10 displays an interesting instructional movie that is especially developed to teach to standardized content that comports with required curriculum standards and associated learning objectives for such standardized tests as the Texas TAKS and TAAS tests.

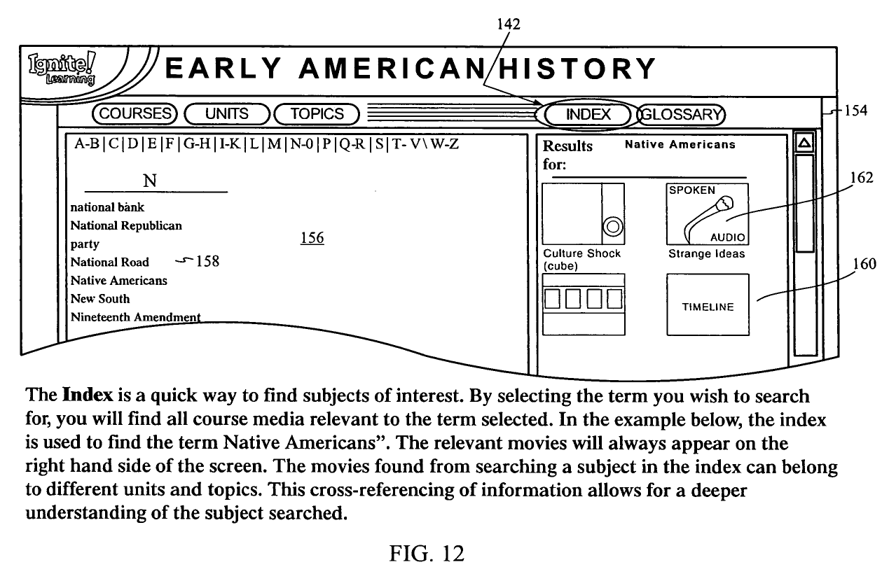

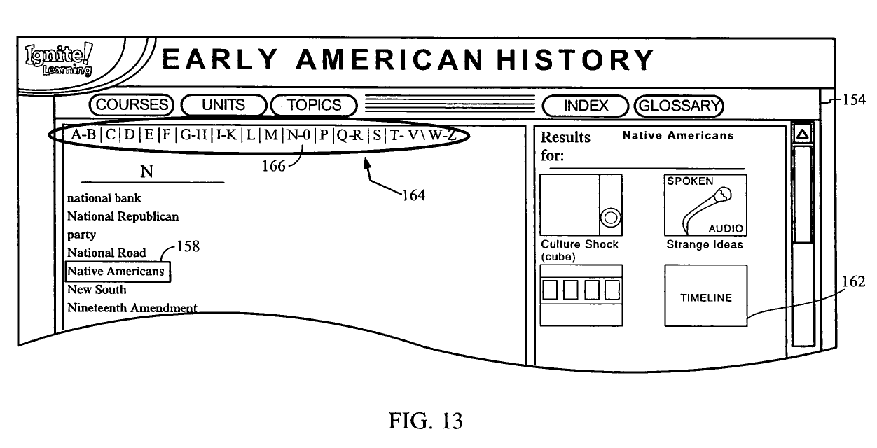

In addition to the rich multimedia content, multimedia curriculum unit 10 provides with each curriculum a robust multimedia index screen 154 of FIG. 12, which a user may access by selecting INDEX button 150 on curriculum navigation button panel 134 (see, FIG. 10). Use of a curriculum index 156 occurs by selecting a hyperlink activated word 158, for example, “Native Americans.” Upon selecting such hyperlinked word 158, the index screen 154 displays multimedia content panel 160, for example, for presenting to the user available multimedia content 162 to which the user may navigate within the multimedia curriculum. Also, as FIG. 13 shows, alphabet array 164 that allows a user to select a hyperlink activated letter set 164, for example, “N-O” letter set 166, and upon which selection index screen 140 displays the list of hyperlinked activated words 158, for example, “Native Americans,” for which to select multimedia content, and display, as here described.

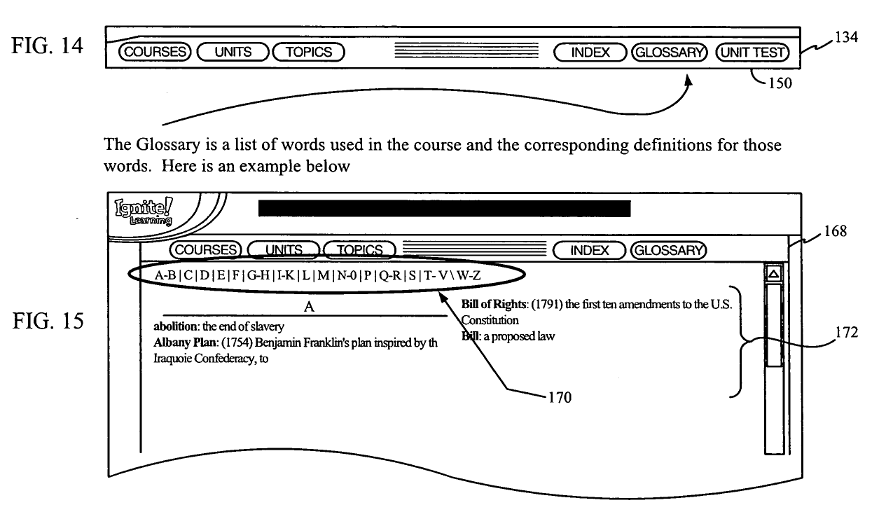

FIG. 14 shows that GLOSSARY button 144 of curriculum navigation button panel 134 may be selected to present glossary screen 168 of FIG. 15. Glossary screen 168 may also include a hyperlink activated letter set 170. Within glossary screen 168 appear definitions and related information 172 for each word or word set that a particular curriculum may include.

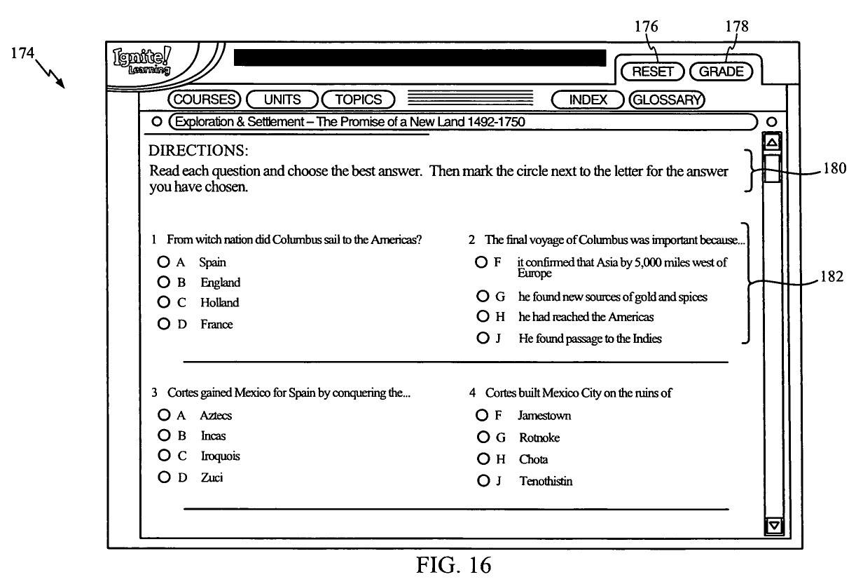

FIG. 16 shows test screen 174 to which a user may navigate by selecting UNIT TEST button 150. Test screen 174 includes RESET button 176 and GRADE button 178. Directions 180 provide directions for operation of a test appearing on test screen 174. A test of test screen 174 may take the form of a set of multiple choice questions 182 to which a learner may respond in taking a unit test for a unit within a given topic. The present embodiment of the disclosed subject matter, therefore, provides a wide variety of testing options that may be suitable for a multimedia device such as multimedia curriculum unit. A key difference with many other devices, however, is that this device includes the relevant content of such testing to a standardized curriculum.

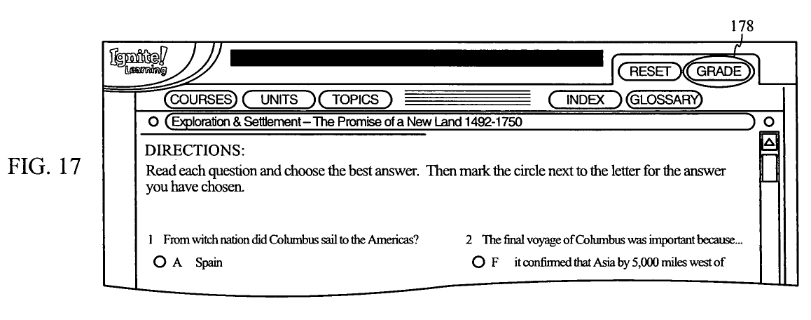

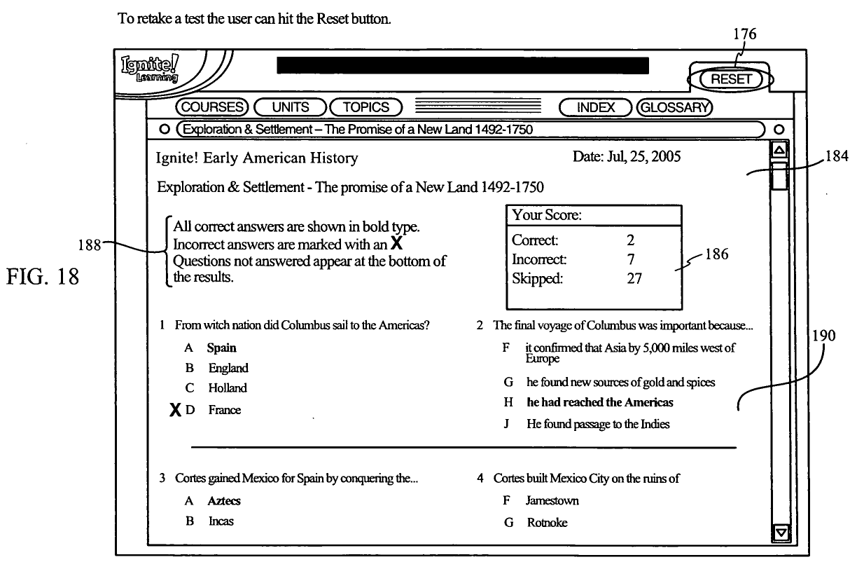

Referring to FIGS. 17 and 18, after taking a test to reinforce the presented curriculum material, a user may select GRADE button 178 to activate a grading function within multimedia curriculum unit 10. In response, graded test screen 184 appears for reporting the results of such a test. Graded test screen 184, for example, includes “Your Score:” template 186 for reporting the test taker(s) score. In addition, graded test screen 184 provides legend 188 for explaining that graded test screen 184 includes graded answers and correct for each of the asked questions. Thus, graded questions 190 include bold type face for the correct multiple choice selections and an “X” to indicate an incorrect answer. There may be many other types of questions and other ways for demonstrating both correct and missed answers.

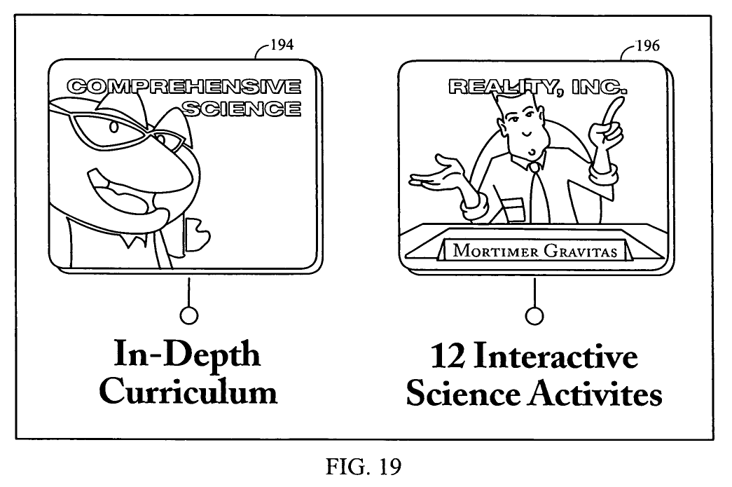

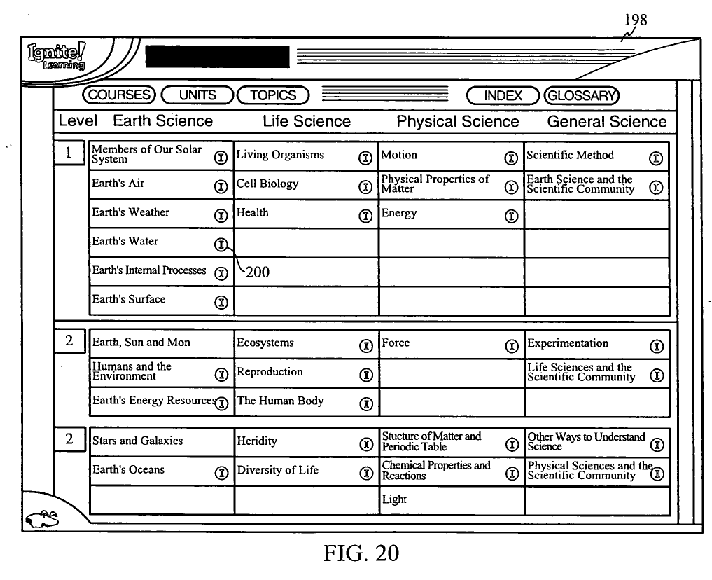

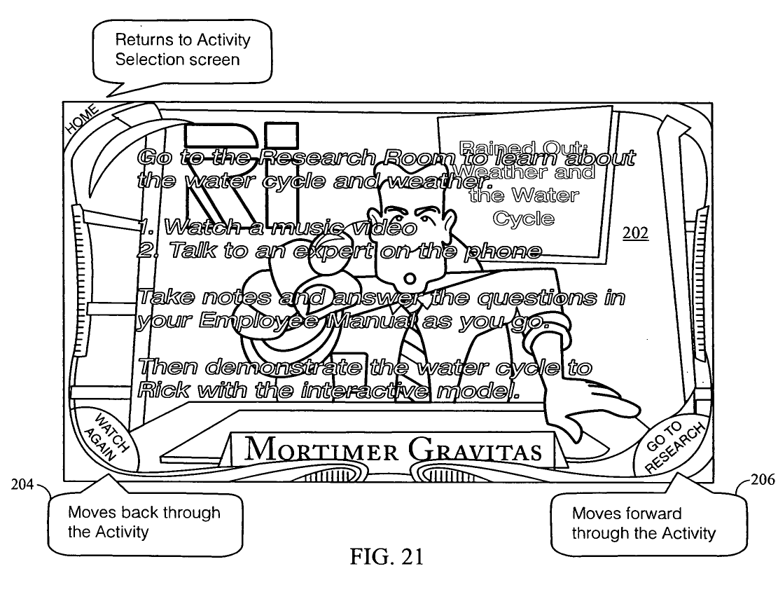

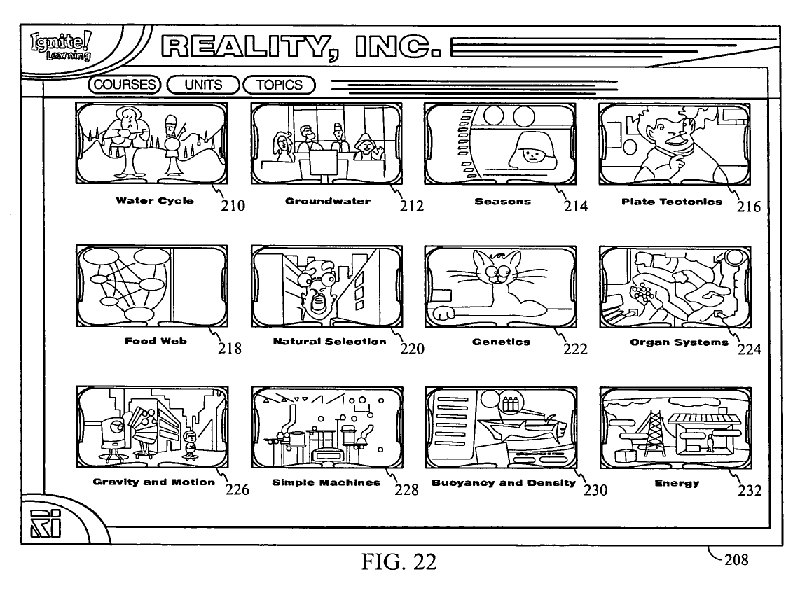

An important aspect of the disclosed subject matter further includes curriculum enhancement content for reinforcing and developing interest in a particular area of study. Accordingly, FIG. 19 shows an example of a science curriculum and activities screen 192 for presenting to a user the option of selecting an in-depth curriculum icon 194 for science teaching or science activities icon 196 for enhancing understanding and interest in the curriculum courses. Upon selecting in-depth curriculum icon 194, science curriculum screen 198 of FIG. 20 appears to the user. Science curriculum screen 198 allows selection from a robust set of interactive, multimedia science courses 200 for teaching science.

On the other hand, upon selecting science activities icon 196 at screen 192, a highly animated screen 202 appears to the user for access the curriculum enhancing content. In the presented scenario, a user navigates to a dark and interesting interview with a seriously, business-type persona called “Mortimer Gravitas,” who is CEO of a company called “Reality, Inc.” After an introduction by Mr. Gravitas, the user may select GO TO RESEARCH icon 204 and navigate to a number of subject enhancing activities. Alternatively, a user may select WATCH AGAIN icon 206 for moving back through a particular activity. Upon selecting GO TO RESEARCH icon 204, REALITY, INC. activities screen 28 appears wherein the user may select from the following types of games, movies, or other activities for topic reinforcement wherein the user seeks to perform the associated tasks as here listed:

(a) The Water Cycle-Convince meteorologist Rick Radar of the importance of the water cycle at icon 206;

(b) Groundwater—Help the town of Salty Lick identify what is causing the saltiness in their drinking water at icon 208;

(c) Earth's Seasons—Blow Saffron the Seer's cover by showing what you know about Earth's seasons at icon 210;

(d) Tectonic Plates—Expose Villainess Morbida Destrukt's lies by identifying the true cause of Earth's hidden forces at icon 212;

(e) Ecosystems & Food Webs—Something has caused Reality River to become overrun by algae! Construct a food web and identify the cause at icon 214;

(f) Natural Selection and Antibiotics—Staff the phone lines at Reality Inc. to help the public learn about antibiotics at icon 216;

(g) Genetics and Heredity—Could cats Cosmo and Calliope possibly be the parents of kitten Marzipan Squishyface? Help the owners discover the truth by learning about genetics and heredity at icon 218;

(h) Internal Organ Systems-Mortimer Gravitas lost his sock in his liver and he needs your help finding it. Map the best path through his internal organs at icon 220;

(i) Newton's Laws of Motion and Gravity-Learn Newton's Laws of Motion and Gravity while editing movie scenes for the latest blockbuster thriller, Aliens on Skateboards at icon 222;

(j) Simple Machines—Make a monkey fly while you learn about simple machines at icon 224;

(k) Density and Buoyancy—Help Don't-Sink-It-Ships build a boat that will actually float while learning about density and buoyancy at icon 226;

(l) Energy—Help Team Reality Inc. beat Team Giant Humungacom in everyone's favorite game show, Seven Degrees of Energy Transfer at icon 228.

In summary, there is provided a self-contained multimedia presentation system for presenting a menu-driven classroom curriculum in compliance with standardized educational requirements. The disclosed system includes a multimedia presentation device for projecting images and playing audio recordings. The multimedia presentation device includes an embedded computing device having a minimal set of control functions for presenting to a user a simplified control interface facilitating use of said multimedia presentation device. A pre-programmed storage medium includes multimedia educational programs for presenting educational material complying with predetermined educational objectives. The predetermined educational objectives prepare learners for specific standardized achievement testing. The standardized achievement testing for which the learner is prepared assures achievement by the learners in satisfying said standardized educational requirements.

The present invention has been described above with reference to a preferred embodiment. However, those skilled in the art will recognize that changes and modifications may be made in this preferred embodiment without departing from the scope of the present invention. The processing features and functions described herein can be implemented in various manners. The foregoing description of the preferred embodiments, therefore, is provided to enable any person skilled in the art to make or use the claimed subject matter. Various modifications to these embodiments will be readily apparent to those skilled in the art, and the generic principles defined herein may be applied to other embodiments without the use of the innovative faculty. Thus, the claimed subject matter is not intended to be limited to the embodiments shown herein but is to be accorded the widest scope consistent with the principles and novel features disclosed herein.

What is claimed is:

1. A self-contained multimedia presentation system for presenting a menu-driven classroom curriculum in compliance with standardized educational requirements, comprising:
a multimedia presentation device for projecting images and playing audio recordings, said multimedia presentation device comprising an embedded computing device, said embedded computing device comprising a minimal set of control functions for presenting to a user a simplified control interface facilitating use of said multimedia presentation device; and
a pre-programmed storage medium comprising engaging multimedia educational programs for presenting educational material complying with predetermined educational objectives, said predetermined educational objectives for preparing learners for geographically specific standardized achievement testing, said standardized achievement testing for determining compliance of said learners in satisfying said standardized educational requirements.

2. The self-contained multimedia presentation system of claim 1, further comprising a plurality of multimedia educational programs comprising pre-programmed educational content, said pre-programmed educational content associated to facilitate integration of said engaging multimedia educational programs with subject matter associated with regionally-standardized educational requirements.

3. The self-contained multimedia presentation system of claim 1, further comprising a plurality of multimedia educational programs comprising pre-programmed educational content, said pre-programmed educational content associated to facilitate integration of said engaging multimedia educational programs with subject matter associated with regionally-standardized educational requirements and comprising a plurality of content navigational functions for facilitating use of said multimedia educational programs through simplified use of a pointing device.

4. The self-contained multimedia presentation system of claim 1, further comprising supporting documentation associated to facilitate integration of said engaging multimedia educational programs with subject matter associated with regionally-standardized educational requirements.

5. The self-contained multimedia presentation system of claim 1, further comprising a plurality of electronic examinations associated with said engaging multimedia educational programs for reinforcing understanding of subject matter associated with regionally-standardized educational requirements.

6. The self-contained multimedia presentation system of claim 1, further comprising a plurality of lesson plans associated with said engaging multimedia educational programs for reinforcing understanding of subject matter associated with regionally-standardized educational requirements.

7. The self-contained multimedia presentation system of claim 1, further comprising a plurality of class activities associated with said engaging multimedia educational programs for reinforcing understanding of subject matter associated with regionally-standardized educational requirements.

8. The self-contained multimedia presentation system of claim 1, further comprising a plurality of class activities associated with said engaging multimedia educational programs for reinforcing understanding of subject matter associated with regionally-standardized educational requirements, said class activities replicating an operating business environment.

9. A method for presenting a menu-driven classroom curriculum using a self-contained multimedia presentation system, said menu-driven classroom curriculum complying with a standardized educational requirements, comprising the steps of:
projecting images and playing audio recordings using a multimedia presentation device an embedded computing device;
presenting to a user a simplified control interface facilitating use of said multimedia presentation device using said embedded computing device comprising a minimal set of control functions; and
presenting educational material complying with predetermined educational objectives using a pre-programmed storage medium comprising engaging multimedia educational programs; and
preparing learners for geographically specific standardized achievement testing in compliance with standardized educational requirements.

10. The method of claim 9, further comprising the step of presenting a plurality of multimedia educational programs comprising pre-programmed educational content, said pre-programmed educational content associated to facilitate integration of said engaging multimedia educational programs with subject matter associated with regionally-standardized educational requirements.

11. The method of claim 9, further comprising the step of presenting a plurality of multimedia educational programs comprising pre-programmed educational content, said pre-programmed educational content associated to facilitate integration of said engaging multimedia educational programs with subject matter associated with regionally-standardized educational requirements and navigating through said multimedia educational programs using a pointing device and a plurality of control icons associated with said multimedia educational programs.

12. The method of claim 9, further comprising the step of using a set of supporting documentation associated to facilitate integration of said engaging multimedia educational programs with subject matter associated with regionally-standardized educational requirements.

13. The method of claim 9, further comprising the step of using a plurality of electronic examinations associated with said engaging multimedia educational programs for reinforcing understanding of subject matter associated with regionally-standardized educational requirements.

14. The method of claim 9, further comprising the step of using a plurality of lesson plans associated with said engaging multimedia educational programs for reinforcing understanding of subject matter associated with regionally-standardized educational requirements.

15. The method of claim 9, further comprising the step of using a plurality of class activities associated with said engaging multimedia educational programs for reinforcing understanding of subject matter associated with regionally-standardized educational requirements.

16. The method of claim 9, further comprising the step of using a plurality of class activities associated with said engaging multimedia educational programs for reinforcing understanding of subject matter associated with regionally-standardized educational requirements, said class activities replicating an operating business environment.

17. A computer readable storage medium for storing a computer operable program, comprising a set of instructions for presenting a menu-driven classroom curriculum using a self-contained multimedia presentation system, said menu-driven classroom curriculum complying with a standardized educational requirements, said set of instructions comprising:
computer readable instructions for projecting images and playing audio recordings using a multimedia presentation device an embedded computing device;
computer readable instructions for presenting to a user a simplified control interface facilitating use of said multimedia presentation device using said embedded computing device comprising a minimal set of control functions;
computer readable instructions for presenting educational material complying with predetermined educational objectives using a pre-programmed storage medium comprising engaging multimedia educational programs; and
computer readable instructions for preparing learners for geographically specific standardized achievement testing in compliance with standardized educational requirements.

18. The computer readable storage medium of claim 17, further comprising computer readable instructions for presenting a plurality of multimedia educational programs comprising pre-programmed educational content, said pre-programmed educational content associated to facilitate integration of said engaging multimedia educational programs with subject matter associated with regionally-standardized educational requirements.

19. The computer readable storage medium of claim 17, further comprising computer readable instructions for presenting a plurality of multimedia educational programs comprising pre-programmed educational content, said pre-programmed educational content associated to facilitate integration of said engaging multimedia educational programs with subject matter associated with regionally-standardized educational requirements and navigating through said multimedia educational programs using a pointing device and a plurality of control icons associated with said multimedia educational programs.

20. The computer readable storage medium of claim 17, further computer readable instructions for using a plurality of electronic examinations associated with said engaging multimedia educational programs for reinforcing understanding of subject matter associated with regionally-standardized educational requirements.
